(19) United States
(12) Patent Application Publication
(10) Pub. No.: US 2012/0253808 A1
(43) Pub. Date: Oct. 4, 2012

(54) Voice Recognition Device and Voice Recognition Method

(76) Inventors: Motonobu Sugiura, Tokyo (JP); Hiroshi Fujimura, Kanagawa (JP)

(21) Appl. No.: 13/274,969

(22) Filed: Oct. 17, 2011

(30) Foreign Application Priority Data
Mar. 31, 2011 (JP) 2011-080107

(51) Int. Cl. G10L 17/00

(52) U.S. Cl. 704/246; 704/E17.001

(57) ABSTRACT

According to an embodiment, a voice recognition device includes a voice inputting unit, a voice recognition processing unit, a vibration movement pattern model holding unit, and a vibration movement unit. The voice recognition processing unit performs voice recognition processing using a digital signal output from the voice inputting unit to output a voice recognition result and outputs voice reliability of the received voice signal. The vibration movement pattern model holding unit stores models prepared according to a number of patterns of the voice reliability output from the voice recognition processing unit and holds vibration movements corresponding to the models. The vibration movement unit detects whether or not the voice reliability output from the voice recognition processing unit matches any one of the models in the vibration movement pattern model holding unit and performs vibration movement predetermined for a matched model.

### CROSS-REFERENCE TO RELATED APPLICATION

This application is based upon and claims the benefit of priority from the Japanese Patent Application No. 2011-80107, filed on Mar. 31, 2011; the entire contents of which are incorporated herein by reference.

### FIELD

An embodiment relates to a voice recognition device and a voice recognition method that can receive voice as a voice command, and convert voice into text and receive the text.

### BACKGROUND

In recent years, mobile terminal equipment such as smartphones and slate (or tablet) PCs that can be operated through a touch-panel display without a keyboard has been developed and has been becoming common.

Such mobile terminal equipment (hereinafter, also simply referred to as terminal equipment) has a plurality of functions, means of calling, and means of communication. The functions include a function to receive voice as a voice command to control editing text and operations of various applications and a function to obtain a document from voice by converting the voice into text and receiving the text by using a voice recognition technique.

In such terminal equipment that can recognize voice, there is a method for reducing a user's stress by giving feedback to the user to let the user know as what voice signal the voice spoken by the user has been received when an application that utilizes voice recognition processing is used. Conventionally, a result of a feedback has been displayed on a screen to let a user know. However, in this system, the users are required to see the screen each time the users speak.

### BRIEF DESCRIPTION OF THE DRAWINGS

FIG. 1 is a block diagram of a voice recognition device according to an embodiment; and

FIG. 2 is a flow chart showing an operation of the voice recognition device according to the embodiment.

### DETAILED DESCRIPTION

A voice recognition device of an embodiment includes a voice inputting unit configured to receive voice, convert the voice into a digital signal, and output the signal; a voice recognition processing unit; a vibration movement pattern model holding unit; and a vibration movement unit. The voice recognition processing unit performs voice recognition processing using the digital signal output from the voice inputting unit to output a voice recognition result and outputs voice reliability of the received voice signal. The vibration movement pattern model holding unit stores models prepared according to a number of patterns of the voice reliability output from the voice recognition processing unit and holds vibration movement patterns corresponding to the models. The vibration movement unit detects whether or not the voice reliability output from the voice recognition processing unit matches any one of the models in the vibration movement pattern model holding unit and performs vibration movement predetermined for a matched model.

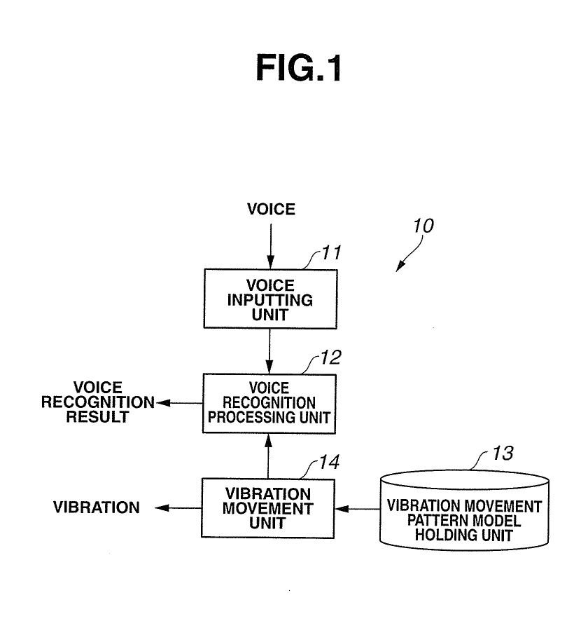

FIG. 1 is a block diagram of a voice recognition device according to an embodiment.

In FIG. 1, a voice recognition device 10 includes a voice inputting unit 11, a voice recognition processing unit 12, a vibration movement pattern model holding unit 13, and a vibration movement unit 14. The voice recognition device 10 is mobile terminal equipment such as smartphones and slate (or tablet) PCs.

The voice inputting unit 11 receives voice, converts the voice into a digital signal, and outputs the signal.

The voice recognition processing unit 12 performs voice recognition processing using the digital signal output from the voice inputting unit 11 and outputs a voice recognition result. At the same time, the voice recognition processing unit 12 calculates and outputs voice recognition reliability (hereinafter, simply referred to as voice reliability) of the received voice signal. The voice recognition processing includes at least one of a process to receive voice as a command to operate a predeteiinined application with the command and a process to convert voice into text.

The vibration movement pattern model holding unit 13 stores models prepared according to a number of patterns of the voice reliability output from the voice recognition processing unit 12 and stores (registers) information of vibration movement patterns corresponding to the models. The vibration movement pattern corresponds to, for example, a number of stages of strength or duration of the vibration movement.

The vibration movement unit 14 detects whether or not the voice reliability output from the voice recognition processing unit 12 matches any one of the models in the vibration movement pattern model holding unit 13 and performs vibration movement predetermined for a matched model.

The voice reliability is a measure defined by likelihood (a degree of probability or plausibility) of a voice recognition result. Specifically, a measure defined by an SN ratio of voice is used, for example.

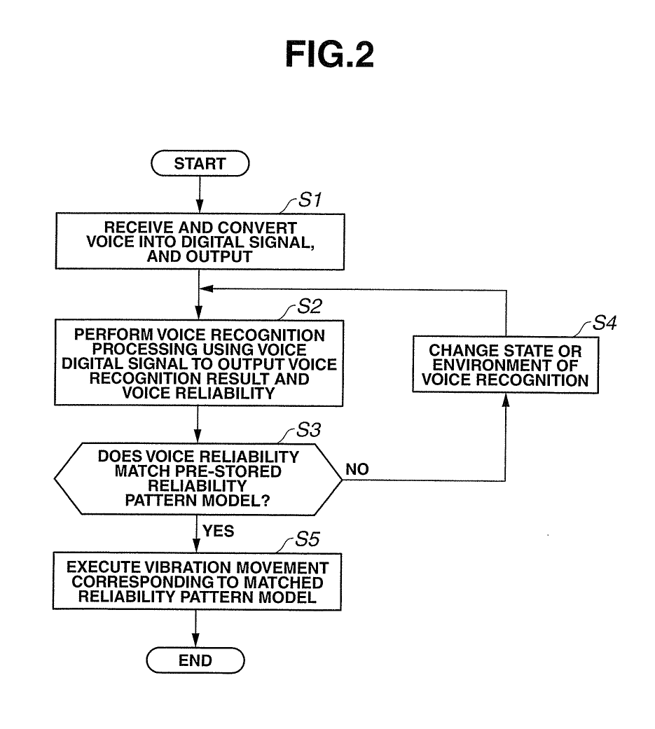

Next, an operation of the voice recognition device 10 according to the present embodiment will be described with reference to a flow chart in FIG. 2.

In a description of the following operation, it is assumed that the vibration movement pattern model holding unit 13 stores models prepared according to a number of patterns of the voice reliability output from the voice recognition processing unit 12 and stores (registers) vibration movement patterns corresponding to the models.

First, in step S1, the voice inputting unit 11 receives voice, converts the voice into a digital signal, and outputs the signal.

Next, in step S2, the voice recognition processing unit 12 performs voice recognition processing using the digital signal output from the voice inputting unit 11 to output a voice recognition result, and, meanwhile, the voice recognition processing unit 12 calculates and outputs voice reliability of the received voice signal.

In step S3, the vibration movement unit 14 detects whether or not the voice reliability output from the voice recognition processing unit 12 matches any one of the voice reliability models stored in the vibration movement pattern model holding unit 13. If the voice reliability matches any one of the models, the processing proceeds to step S5. If the voice reliability does not match any one of the models, the processing proceeds to step S4, where a user gradually changes the sensitivity of the voice recognition or a place in which the voice recognition device 10 is set so as to change a state or an environment of the voice recognition, while the processing returns to step S2 and then proceeds to step S3. The flow is repeated, and thereby a matched state is obtained in step S3, and then the processing can proceed to step S5.

In step S5, the vibration movement unit 14 detects a vibration movement pattern predetermined for the matched reliability pattern model from the holding unit 13 to perform vibration movement. As a result, vibration having strength (or duration) corresponding to a level of the voice reliability is generated. That is, the vibration movement unit 14 changes the strength or the duration of the vibration movement depending on the level of the voice reliability.

Besides vibration movement corresponding to a level of the voice reliability, the vibration movement unit 14 may perform the vibration movement only when the voice reliability is low or conversely or perform the vibration movement only when the voice reliability is high. That is, the more difficult to catch generated sound because of low voice reliability, in other words, the more difficult to recognize voice, the stronger vibration may be fed back to the user. Or conversely, the easier to catch generated sound, in other words, the easier to recognize voice, the stronger vibration may be fed back. In particular, if the more difficult to catch sound because of low voice reliability, the stronger vibration (feedback) is given to the user, there arises an advantage that the feedback helps the user to speak naturally to be easily recognized.

According to the embodiment described above, a user can receive a feedback on user voice from voice recognition processing side without viewing a screen.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A voice recognition device comprising:
a voice inputting unit configured to receive voice, convert the voice into a digital signal, and output the signal;
a voice recognition processing unit configured to perform voice recognition processing using the digital signal output from the voice inputting unit to output a voice recognition result and output voice reliability of the received voice signal;
a vibration movement pattern model holding unit configured to store models prepared according to a number of patterns of the voice reliability output from the voice recognition processing unit and hold vibration movement patterns corresponding to the models; and
a vibration movement unit configured to detect whether or not the voice reliability output from the voice recognition processing unit matches any one of the models in the vibration movement pattern model holding unit and perform vibration movement predetermined for a matched model.

2. The voice recognition device according to claim 1, wherein the voice reliability is a measure defined by likelihood of a voice recognition result.

3. The voice recognition device according to claim 1, wherein the voice reliability is a measure defined by an SN ratio of voice.

4. The voice recognition device according to claim 1, wherein the vibration movement unit changes duration or strength of the vibration movement depending on a level of the voice reliability.

5. The voice recognition device according to claim 1, wherein the vibration movement unit performs vibration movement only when the voice reliability is low.

6. The voice recognition device according to claim 1, wherein the vibration movement unit performs vibration movement only when the voice reliability is high.

7. The voice recognition device according to claim 1, wherein the voice recognition processing includes at least one of a process to receive voice as a command to operate a predetermined application with the command and a process to convert voice into text.

8. The voice recognition device according to claim 1, wherein the voice recognition device is mobile terminal equipment.

9. A voice recognition method comprising:
receiving voice, converting the voice into a digital signal, and outputting the signal;
performing voice recognition processing using the output voice digital signal and outputting a voice recognition result and voice reliability of the received voice signal;
detecting, with a state or an environment of the voice recognition being changed, whether or not the output voice reliability matches any one of predetermined voice reliability pattern models stored in a holding unit storing the voice reliability pattern models and predetermined vibration movement patterns corresponding to the models; and
performing, if matching is detected, vibration movement corresponding to a matched voice reliability pattern model.

10. The voice recognition method according to claim 9, wherein the voice reliability is a measure defined by likelihood of a voice recognition result.

11. The voice recognition method according to claim 9, wherein the voice reliability is a measure defined by an SN ratio of voice.

12. The voice recognition method according to claim 9, wherein duration or strength of the vibration movement is changed depending on a level of the voice reliability.

13. The voice recognition method according to claim 9, wherein the vibration movement is performed only when the voice reliability is low.

14. The voice recognition method according to claim 9, wherein the vibration movement is performed only when the voice reliability is high.

15. The voice recognition method according to claim 9, wherein the voice recognition processing includes at least one of a process to receive voice as a command to operate a predetermined application with the command and a process to convert voice into text.
